(19) United States
(12) Patent Application Publication
(10) Pub. No.: US 2022/0365655 A1
(43) Pub. Date: Nov. 17, 2022

(54) Virtual Keyboard Interaction Method and System

(71) Applicant: QINGDAO PICO TECHNOLOGY CO., LTD., Qingdao (CN)

(72) Inventor: Tao WU, Qingdao (CN)

(21) Appl. No.: 17/816,413

(22) Filed: Jul. 30, 2022

Related U.S. Application Data
(63) Continuation of application No. PCT/CN2021/121388, filed on Sep. 28, 2021.

(30) Foreign Application Priority Data
May 10, 2021 (CN) 202110505160.1

(51) Int. Cl. G06F 3/041; G06F 3/04886; G06T 7/50; G06N 3/08

(52) U.S. Cl. CPC G06F 3/04186; G06F 3/04886; G06T 7/50; G06N 3/08; G06T 2207/10028; G06T 2207/20081; G06T 2207/20084

(57) ABSTRACT

The present disclosure provides a virtual keyboard interface method and system. The method includes pre-training a fingertip detection model; acquiring, by using the fingertip detection model, three-dimensional spatial position coordinates, relative to a preset reference position, of all fingertips on image data to be detected; determining, based on the three-dimensional spatial position coordinates, touch control regions corresponding to the fingertips; in a case where a touch control region overlaps a sensing region of a preset virtual keyboard, acquiring volume information of the touch control region submerged in the sensing region; and determining, based on the volume information and a preset rule, whether the virtual keyboard where the sensing region corresponding to the touch control region is located is triggered.

### CROSS-REFERENCE TO RELATED APPLICATION

This application is a national stage filing of PCT Application No. PCT/CN2021/121388 filed on Sep. 28, 2021, which claims priority to Chinese patent application No. 202110505160.1 to China National Intellectual Property Administration, filed on May 10, 2021 and entitled “Virtual Keyboard Interaction Method and System”, the disclosure of which is incorporated by reference herein in its entirety as part of the present disclosure.

### TECHNICAL FIELD

The present disclosure relates to the technical field of virtual keyboards, more specifically to a virtual keyboard interaction method and system.

### BACKGROUND

With the development of computer games, health and safety, industry, education, and other fields, it is more and more common that artificial reality systems are applied to these fields. For example, artificial reality systems are being integrated into mobile devices, game consoles, personal computers, cinemas, theme parks, etc. Artificial reality is a form of reality adjusted in a certain way before being presented to users, which can include, for example, virtual reality (VR), augmented reality (AR), mixed reality (MR), or some combination and/or derivatives thereof.

With the population and development of the artificial reality in all trades and professions, keyboards have been inherited as one of the most common input devices for interaction between users and artificial reality systems. Generally, a virtual keyboard is mainly rendered and projected directly in front of the user's view through a virtual reality head-mounted display device (HMD), but the virtual keyboard in related art does not have the characteristic of contributing to the success of a physical keyboard. For example, users cannot put their hands on the virtual keyboard, there is no landmark to determine directions of users' hands, and/or there is no tactile feedback to indicate that a key has been successfully activated, thus affecting the input experience of the users.

In addition, the ways of relying on external devices to implement user participation in related art, for example, a method in which a user uses a handle controller to call characters on respective keys to select these keys, have the problems of slow and inconvenient inputting, low character inputting efficiency, low intelligence degree, and the like.

### SUMMARY

Embodiments of the present disclosure provide a virtual keyboard interaction method and system, which can solve the problems that a current artificial reality system is slow in inputting and low in efficiency and affects the user experience.

The virtual keyboard interface method provided by the embodiments of the present disclosure includes: pre-training a fingertip detection model; acquiring, by using the fingertip detection model, three-dimensional spatial position coordinates, relative to a preset reference position, of all fingertips on image data to be detected; determining, based on the three-dimensional spatial position coordinates, touch control regions corresponding to the fingertips; in a case where a touch control region overlaps a sensing region of a preset virtual keyboard, acquiring volume information of the touch control region submerged in the sensing region; and determining, based on the volume information and a preset rule, whether the virtual keyboard where the sensing region corresponding to the touch control region is located is triggered.

In at least one exemplary embodiment, pre-training a fingertip detection model includes: acquiring image data of movement of sample fingers; marking fingertip information on the image data to acquire marked image data; and training a neural network model based on the marked image data till the neural network model is converged within a preset range to form the fingertip detection model.

In at least one exemplary embodiment, in a process of acquiring the three-dimensional spatial position coordinates, relative to the preset reference position, of all the fingertips on the image data to be detected, in a case where the image data to be detected is acquired through a depth camera, the three-dimensional spatial position coordinates, relative to the depth camera, of the fingertips are directly acquired by using the fingertip detection model; in a case where the image data to be detected is acquired through a visible light camera, image position information of the fingertips on two pieces of image data to be detected is acquired respectively by using the fingertip detection model, and the three-dimensional spatial position coordinates, relative to the visible light camera, of the fingertips are acquired according to a triangulation stereo imaging principle.

In at least one exemplary embodiment, determining the touch control regions corresponding to the fingertips includes: determining spherical regions, in which the three-dimensional spatial position coordinates of the fingertips serve as spherical centers and preset distances serve as radiuses, as the touch control regions corresponding to the fingertips.

In at least one exemplary embodiment, the preset distances are in a range of 2 mm to 7 mm.

In at least one exemplary embodiment, the preset reference position is a coordinate origin position of a camera for acquiring the image data to be detected.

In at least one exemplary embodiment, determining, based on the volume information and a preset rule, whether the virtual keyboard where the sensing region corresponding to the touch control region is located is triggered includes: acquiring a ratio of the volume information to a volume value of the sensing region, so as to acquire a probability distribution of an overlapping region of the touch control region and the sensing region; determining whether the probability distribution is greater than a preset threshold; and in a case where the probability distribution is greater than the preset threshold, determining that a key, where the sensing region is located, of the virtual keyboard is selected.

In at least one exemplary embodiment, after the key is selected once, the method further includes: determining whether probability distributions corresponding to the key in a preset number of continuous frames of the image data to be detected are all greater than the preset threshold; in a case where the probability distributions corresponding to the key in the preset number of continuous frames of the image data to be detected are all greater than the preset threshold, triggering a character corresponding to the key; otherwise, not triggering the character corresponding to the key.

In at least one exemplary embodiment, the preset threshold is 0.75.

In at least one exemplary embodiment, the preset number of frames are 3 frames.

In at least one exemplary embodiment, the sensing region includes a three-dimensional spatial region under a coordinate system of a camera used for acquiring the image data to be detected, and one three-dimensional spatial region is allocated for each virtual key.

According to another aspect of the embodiments of the present disclosure, a virtual keyboard interface system is provided, including: a fingertip detection model training unit, configured to pre-train a fingertip detection model; a three-dimensional spatial position coordinate acquisition unit, configured to acquire, by using the fingertip detection model, three-dimensional spatial position coordinates, relative to a preset reference position, of all fingertips on image data to be detected; a touch control region determination unit, configured to determine, based on the three-dimensional spatial position coordinates, touch control regions corresponding to the fingertips; a volume information acquisition unit, configured to acquire, in a case where a touch control region overlaps a sensing region of a preset virtual keyboard, volume information of the touch control region submerged in the sensing region; and a virtual keyboard trigger determining unit, configured to determine, based on the volume information and a preset rule, whether the virtual keyboard where the sensing region corresponding to the touch control region is located is triggered.

According to another aspect of the embodiments of the present disclosure, an electronic apparatus is provided, including the virtual keyboard interaction system in the foregoing embodiment, or including a memory and a processor. The memory is configured to store a computer instruction. The processor is configured to call the computer instruction from the memory to implement the virtual keyboard interaction method in any one of the above embodiments.

According to another aspect of the embodiments of the present disclosure, a computer-readable storage medium is provided, which stores a computer program. The computer program, when executed by a processor, implements the virtual keyboard interaction method in any one of the above embodiments.

According to the above virtual keyboard interface method and system, three-dimensional spatial position coordinates, relative to a preset reference position, of all fingertips on image data to be detected are acquired by using a pre-trained fingertip detection model; touch control regions corresponding to the fingertips are determined based on the three-dimensional spatial position coordinates; in a case where a touch control region overlaps a sensing region of a preset virtual keyboard, volume information of the touch control region submerged in the sensing region is acquired; and whether the virtual keyboard where the sensing region corresponding to the touch control region is located is triggered is determined based on the volume information and a preset rule. By virtue of the solution, a user can conveniently and quickly interact with the virtual keyboard, the character inputting accuracy is improved, and a more satisfactory user experience is realized.

In order to achieve the above and related objects, one or more aspects of the embodiments of the present disclosure include features that will be described in detail later. The following description and drawings illustrate certain exemplary aspects of the embodiments of the present disclosure in detail. However, these aspects indicate only some of the various ways in which the principles of the embodiments of the present disclosure can be used. Furthermore, the present disclosure is intended to include all these aspects and their equivalents.

### BRIEF DESCRIPTION OF THE DRAWINGS

By referring to the following description in conjunction with the accompanying drawings, and with a more comprehensive understanding of the embodiments of the present disclosure, other objectives and results of the present disclosure will be clearer and easy to understand. In the drawings:

FIG. 1 is a flowchart of a virtual keyboard interaction method according to the embodiments of the present disclosure; and

FIG. 2 is a schematic block diagram of a virtual keyboard interaction system according to the embodiments of the present disclosure,

The same reference numerals in all the drawings indicate similar or corresponding features or functions.

### DETAILED DESCRIPTION OF THE EMBODIMENTS

In the following description, for illustrative purposes, in order to provide a comprehensive understanding of one or more embodiments, many exemplary details are set forth. However, it is apparent that these embodiments can also be implemented without these exemplary details. In other examples, for the convenience of describing one or more embodiments, well-known structures and devices are shown in the form of block diagrams.

In the description of the embodiments of the present disclosure, it should be understood that orientations or positional relationships indicated by the terms “center”, “longitudinal”, “transverse”, “length” “width”, “thickness”, “upper”, “lower”, “front”, “rear”, “left”, “right”, “vertical”, “horizontal”, “top”, “bottom”, “inside”, “outside”, “clockwise”, “anticlockwise”, “axial”, “radial”, “circumferential” and the like are orientations or positional relationships as shown in the drawings, and are only for the purpose of facilitating and simplifying the description of the embodiments of the present disclosure instead of indicating or implying that apparatuses or elements indicated must have particular orientations, and be constructed and operated in the particular orientations, so that these terms are not construed as limiting the present disclosure.

To describe the virtual keyboard interaction method and system of the embodiments of the present disclosure, the exemplary embodiments of the present disclosure will be described in detail below in combination with the accompanying drawings.

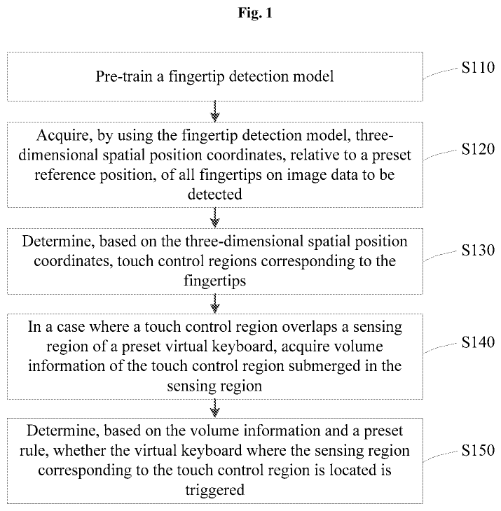

FIG. 1 illustrates a flow of a virtual keyboard interaction method according to the embodiments of the present disclosure.

As shown in FIG. 1, the virtual keyboard interaction method according to the embodiments of the present disclosure includes operations S110 to S150 which are described in detail below.

At S110, a fingertip detection model is pre-trained.

At S120, three-dimensional spatial position coordinates, relative to a preset reference position, of all fingertips on image data to be detected are acquired by using the fingertip detection model.

At S130, touch control regions corresponding to the fingertips are determined based on the three-dimensional spatial position coordinates.

At S140, in a case where a touch control region overlaps a sensing region of a preset virtual keyboard, volume information of the touch control region submerged in the sensing region is acquired.

At S150, whether the virtual keyboard where the sensing region corresponding to the touch control region is located is triggered is determined based on the volume information and a preset rule.

As an exemplary implementation, the operation S110 of pre-training a fingertip detection model includes operations S111 to S113 which are described in detail below. At S111, image data of movement of sample fingers is acquired. At S112, fingertip information is marked on the image data to acquire marked image data. At S113, a neural network model is trained based on the marked image data till the neural network model is converged within a preset range to form the fingertip detection model.

For different image data acquisition methods, there are two types of corresponding fingertip detection models. If a depth camera is provided in a virtual reality head-mounted display device (HMD), in an interaction scenario of the virtual keyboard provided according to the embodiments of the present disclosure, finger movement data, including about 3 million of pieces of image data, of the depth camera in the HMD is acquired. Fingertip information of 10 fingers of the left and right hands is marked on the image data, and a convolutional neural network model is trained based on the marked image data, so as to obtain a corresponding high-accuracy fingertip detection model. If a visible light camera is provided in the HMD, in an interaction scenario of the virtual keyboard provided according to the embodiments of the present disclosure, finger movement data, including about 3 million of pieces of left and right (visible light) image data, may be acquired through at least two visible light cameras. Fingertip information of 10 fingers of the left and right hands is marked on the (visible light) image data, and a convolutional neural network model is trained based on the marked image data, so as to obtain a corresponding fingertip detection model.

In the process of acquiring, by using the fingertip detection model, the three-dimensional spatial position coordinates of all the fingertips on the image data to be detected relative to the preset reference position, in a case where the image data to be detected is acquired through a depth camera, the three-dimensional spatial position coordinates, relative to the depth camera, of the fingertips are directly acquired by using the fingertip detection model. In a case where the image data to be detected is acquired through a visible light camera, image position information of the fingertips on two pieces of image data to be detected is acquired respectively by using the fingertip detection model, and the three-dimensional spatial position coordinates, relative to the visible light camera, of the fingertips are acquired according to a triangulation stereo imaging principle.

As an exemplary implementation, the above preset reference position may be a coordinate origin position of the camera used for acquiring the image data to be detected.

According to the operation S120, the three-dimensional spatial position coordinates of all the fingertips of both hands of a user at the current moment are acquired in sequence, and then one touch control region is allocated for the three-dimensional spatial position coordinates of each fingertip. As an exemplary implementation, spherical regions, in which the three-dimensional spatial position coordinates of the fingertips serve as spherical centers and preset distances serve as radiuses, are determined as the touch control regions corresponding to the fingertips.

As a specific example, the preset distance may be set to be in a range of 2 mm to 7 mm. Generally, a spherical region taking the three-dimensional spatial position coordinates of each fingertip as a center and taking 5 mm as a radius may be determined as the touch control region.

It should be noted that the sensing region of the virtual keyboard may be set as a three-dimensional spatial region under a coordinate system of a camera provided in the HMD. That is, one three-dimensional spatial region is allocated for each virtual key. In order to improve the sensitivity of finger touch control, a volume of the sensing region of each key of the virtual keyboard is set to be 15 mm*15 mm*15 mm (length*width*height). According to the volume parameters of the virtual keyboard, each key of this virtual keyboard under the coordinate system of the camera provided in the HMD has one sensing region in a corresponding three-dimensional space. When it is determined that there is a certain probability that the region (the touch control region) of a fingertip is submerged into a cube region of this key, the character of the key corresponding to this region is input into a virtual reality content.

The operation S150 of determining, based on the volume information and a preset rule, whether the virtual keyboard where the sensing region corresponding to the touch control region is located is triggered includes: a ratio of the volume information to a volume value of the sensing region is acquired, so as to acquire a probability distribution of an overlapping region of the touch control region and the sensing region; whether the probability distribution is greater than a preset threshold is determined; and in a case where the probability distribution is greater than the preset threshold, it is determined that a key, where the sensing region is located, of the virtual keyboard is selected.

As an exemplary implementation, the touch control region of each fingertip is detected and analyzed to confirm whether there is one or more touch control regions submerged in the sensing regions of some keys on the virtual keyboard. When there is a touch control region submerged in the sensing region, the volume information T of the touch control region submerged in the sensing region is determined, and a probability distribution that the key is selected and input by the user is calculated. For example, the probability distribution is calculated as T/(15 mm*15 mm*15 mm). When the probability distribution is greater than a preset threshold, it is determined that the key of the virtual keyboard where the sensing region is located is selected.

As a specific example, the preset threshold may be set to be 0.75. The range of the sensing region, the range of the preset threshold, and the range of the touch control region may be set and adjusted according to the specific size of the virtual keyboard or the user experience, and are not specifically limited.

In an exemplary implementation of the present disclosure, after it is determined that the key is selected once, the method further includes: whether probability distributions corresponding to the key in a preset number of continuous frames of the image data to be detected are all greater than the preset threshold is determined; in a case where the probability distributions corresponding to the key in the preset number of continuous frames of the image data to be detected are all greater than the preset threshold, a character corresponding to the key is triggered; otherwise, the character corresponding to the key is not triggered.

The above preset number of continuous frames may be set to be 3 frames. If detection of 3 continuous frames of images of the current key shows that the probability distributions of selection in the 3 continuous frames of images are greater than 0.75, the character corresponding to the key is input into a current virtual reality content.

By virtue of the virtual keyboard interaction method provided by the embodiments of the present disclosure, intelligent interaction between the user and the virtual keyboard can be conveniently and quickly realized, and key inputting is fast and high in accuracy, thus achieving a faster effect and a more satisfactory user experience.

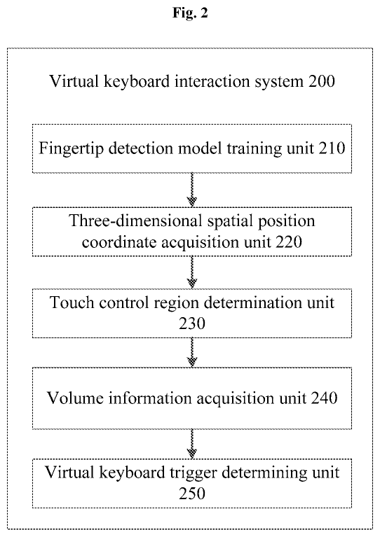

Corresponding to the virtual keyboard interaction method, the embodiments of the present disclosure provide a virtual keyboard interaction system. FIG. 2 illustrates a schematic logic of a virtual keyboard interaction system according to the embodiments of the present disclosure.

As shown in FIG. 2, the virtual keyboard interaction system 200 according to the embodiments of the present disclosure includes:

a fingertip detection model training unit 210, configured to pre-train a fingertip detection model;

a three-dimensional spatial position coordinate acquisition unit 220, configured to acquire, by using the fingertip detection model, three-dimensional spatial position coordinates, relative to a preset reference position, of all fingertips on image data to be detected;

a touch control region determination unit 230, configured to determine, based on the three-dimensional spatial position coordinates, touch control regions corresponding to the fingertips;

a volume information acquisition unit 240, configured to acquire, in a case where a touch control region overlaps a sensing region of a preset virtual keyboard, volume information of the touch control region submerged in the sensing region; and a virtual keyboard trigger determining unit 250, configured to determine, based on the volume information and a preset rule, whether the virtual keyboard where the sensing region corresponding to the touch control region is located is triggered.

It should be noted that the embodiment of the virtual keyboard interaction system may refer to the description in the embodiments of the virtual keyboard interaction method, and descriptions thereof are omitted here.

The embodiments of the present disclosure provide an electronic apparatus. The apparatus may include the virtual keyboard interaction system 200 as shown in FIG. 2, or may include a memory and a processor. The memory is configured to store a computer instruction. The processor is configured to call the computer instruction from the memory to implement any virtual keyboard interaction method provided in the above method embodiments.

The embodiments of the present disclosure provide a computer-readable storage medium, which stores a computer program. The computer program, when executed by a processor, implements any virtual keyboard interaction method provided according to the above method embodiments.

By means of the virtual keyboard interaction method and system provided by the embodiments of the present disclosure, a virtual keyboard is rendered and displayed by the HMD at a preset position from a viewing angle in front of the user. The user can simulate a way of using a physical keyboard with both hands, and an input operation for virtual keys can be performed with 10 fingers of the both hands of the user. The virtual keyboard located in front of the viewing angle of the eyes of the user is generated based on the HMD rendering. The movement information of the left and right fingers of the user is detected in real time by using a convolutional neural network model, and movement path information of the fingertips in a 3D space close to a sensing position of the virtual keyboard is detected. A path distribution of the fingers of the user on the virtual keys in the movement process is tracked, and parameters related to the inputting interaction of the user are acquired. These parameters can be used for calculating the probabilities that the user intends to select which keys. The probability distributions of all the keys in a certain time sequence are analyzed to confirm the keys that are really selected by the user, and the characters corresponding to the selected keys are input to the virtual reality, thus improving the user experience of inputting on the keys of the virtual keyboard.

As above, the virtual keyboard interaction method and system according to the embodiments of the present disclosure are described by way of examples with reference to the accompanying drawings. However, those having ordinary skill in the art should understand that various improvements can be made to the virtual keyboard interaction method and system provided in the embodiments of the present disclosure without departing from the content of the present disclosure. Therefore, the protection scope of the present disclosure should be determined by the content of the appended claims.

What is claimed is:

1. A virtual keyboard interaction method, comprising:
obtaining a pre-trained fingertip detection model;
acquiring, by using the fingertip detection model, three-dimensional spatial position coordinates, relative to a preset reference position, of all fingertips on image data to be detected;
determining, based on the three-dimensional spatial position coordinates, touch control regions corresponding to the fingertips;
in a case where a touch control region overlaps a sensing region of a preset virtual keyboard, acquiring volume information of the touch control region submerged in the sensing region; and
determining, based on the volume information and a preset rule, whether the virtual keyboard where the sensing region corresponding to the touch control region is located is triggered.

2. The virtual keyboard interaction method according to claim 1, wherein obtaining a pre-trained fingertip detection model comprises:
acquiring image data of movement of sample fingers;
marking fingertip information on the image data to acquire marked image data; and
training a neural network model based on the marked image data till the neural network model is converged within a preset range to form the fingertip detection model.

3. The virtual keyboard interaction method according to claim 1, wherein in a process of acquiring the three-dimensional spatial position coordinates, relative to the preset reference position, of all the fingertips on the image data to be detected,
in a case where the image data to be detected is acquired through a depth camera, the three-dimensional spatial position coordinates, relative to the depth camera, of the fingertips are directly acquired by using the fingertip detection model.

4. The virtual keyboard interaction method according to claim 1, wherein determining the touch control regions corresponding to the fingertips comprises:
determining spherical regions, in which the three-dimensional spatial position coordinates of the fingertips serve as spherical centers and preset distances serve as radiuses, as the touch control regions corresponding to the fingertips.

5. The virtual keyboard interaction method according to claim 4, wherein
the preset distances are in a range of 2 mm to 7 mm.

6. The virtual keyboard interaction method according to claim 4, wherein
the preset reference position is a coordinate origin position of a camera for acquiring the image data to be detected.

7. The virtual keyboard interaction method according to claim 1, wherein determining, based on the volume information and a preset rule, whether the virtual keyboard where the sensing region corresponding to the touch control region is located is triggered comprises:
acquiring a ratio of the volume information to a volume value of the sensing region, and determining the ratio as a probability distribution of an overlapping region of the touch control region and the sensing region;
determining whether the probability distribution is greater than a preset threshold; and in a case where the probability distribution is greater than the preset threshold, determining that a key, where the sensing region is located, of the virtual keyboard is selected.

8. The virtual keyboard interaction method according to claim 7, wherein after the key is selected once, the method further comprises:
determining whether probability distributions corresponding to the key in a preset number of continuous frames of the image data to be detected are all greater than the preset threshold;
in a case where the probability distributions corresponding to the key in the preset number of continuous frames of the image data to be detected are all greater than the preset threshold, triggering a character corresponding to the key; otherwise, not triggering the character corresponding to the key.

9. The virtual keyboard interaction method according to claim 7, wherein
the preset threshold is 0.75.

10. The virtual keyboard interaction method according to claim 7, wherein
the preset number of frames are 3 frames.

11. The virtual keyboard interaction method according to claim 1, wherein the sensing region comprises a three-dimensional spatial region under a coordinate system of a camera used for acquiring the image data to be detected, and one three-dimensional spatial region is allocated for each virtual key.

12. A virtual keyboard interaction system, comprising a memory storing instructions and a processor in communication with the memory, wherein the processor is configured to execute the instructions to:
obtain a pre-trained fingertip detection model;
acquire, by using the fingertip detection model, three-dimensional spatial position coordinates, relative to a preset reference position, of all fingertips on image data to be detected;
determine, based on the three-dimensional spatial position coordinates, touch control regions corresponding to the fingertips;
acquire, in a case where a touch control region overlaps a sensing region of a preset virtual keyboard, volume information of the touch control region submerged in the sensing region; and
determine, based on the volume information and a preset rule, whether the virtual keyboard where the sensing region corresponding to the touch control region is located is triggered.

13. An electronic apparatus, comprising the system according to claim 12.

14. A non-transitory computer-readable storage medium, which stores a computer program, wherein the computer program, when executed by a processor, implements the method according to claim 1.

15. The virtual keyboard interaction method according to claim 1, wherein in a process of acquiring the three-dimensional spatial position coordinates, relative to the preset reference position, of all the fingertips on the image data to be detected,
in a case where the image data to be detected is acquired through a visible light camera, image position information of the fingertips on two pieces of image data to be detected is acquired respectively by using the fingertip detection model, and the three-dimensional spatial position coordinates, relative to the visible light camera, of the fingertips are acquired according to a triangulation stereo imaging principle.

16. The virtual keyboard interaction system according to claim 12, wherein the processor is configured to execute the instructions to:
acquiring image data of movement of sample fingers;
marking fingertip information on the image data to acquire marked image data; and
training a neural network model based on the marked image data till the neural network model is converged within a preset range to form the fingertip detection model.

17. The virtual keyboard interaction system according to claim 12, wherein the processor is configured to execute the instructions to: in a process of acquiring the three-dimensional spatial position coordinates, relative to the preset reference position, of all the fingertips on the image data to be detected,
in a case where the image data to be detected is acquired through a depth camera, directly acquire, by using the fingertip detection model, the three-dimensional spatial position coordinates, relative to the depth camera, of the fingertips.

18. The virtual keyboard interaction system according to claim 12, wherein the processor is configured to execute the instructions to: in a process of acquiring the three-dimensional spatial position coordinates, relative to the preset reference position, of all the fingertips on the image data to be detected,
in a case where the image data to be detected is acquired through a visible light camera, acquire, by using the fingertip detection model, image position information of the fingertips on two pieces of image data to be detected respectively, and acquire the three-dimensional spatial position coordinates, relative to the visible light camera, of the fingertips according to a triangulation stereo imaging principle.

19. The virtual keyboard interaction system according to claim 12, wherein the processor is configured to execute the instructions to:
determine spherical regions, in which the three-dimensional spatial position coordinates of the fingertips serve as spherical centers and preset distances serve as radiuses, as the touch control regions corresponding to the fingertips.

20. The virtual keyboard interaction system according to claim 12, wherein the processor is configured to execute the instructions to:
acquire a ratio of the volume information to a volume value of the sensing region, and determine the ratio as a probability distribution of an overlapping region of the touch control region and the sensing region;
determine whether the probability distribution is greater than a preset threshold; and in a case where the probability distribution is greater than the preset threshold, determine that a key, where the sensing region is located, of the virtual keyboard is selected.
